(19) United States
(12) Patent Application Publication
(10) Pub. No.: US 2022/0264884 A1
(43) Pub. Date: Aug. 25, 2022

(54) SYNERGISTIC FUNGICIDE COMPOSITION

(71) Applicant: UPL LIMITED, Maharashtra, Mumbai (IN)

(72) Inventors: Shiv Kumar Sharma, Mumbai (IN); Rajan Ramakant Shirsat, Mumbai (IN); Pradeep Shamrao Sapkale, Mumbai (IN); Chetan Madhukar Zade, Mumbai (IN); Pramod Vidhate, Mumbai (IN); Tusharkumar Bhagwat Chakhale, Mumbai (IN); Umakant Govind Mahajan, Mumbai (IN); Satish Ekanath Bhoge, Mumbai (IN)

(21) Appl. No.: 17/622,379

(22) PCT Filed: Jun. 12, 2020
(86) PCT No.: PCT/IB2020/055512

§ 371 Date: Dec. 23, 2021

(30) Foreign Application Priority Data
Jun. 24, 2019 (IN) 201921025053
Feb. 3, 2020 (IN) 202021004685
Feb. 3, 2020 (IN) 202021004688

(51) Int. Cl. A01N 47/14; A01N 43/653; A01N 55/02; A01N 25/14; A01N 43/52; A01N 59/20; A01P 3/00

(52) U.S. Cl. CPC A01N 47/14; A01N 43/653; A01N 55/02; A01P 3/00; A01N 43/52; A01N 59/20; A01N 25/14

(57) ABSTRACT

Disclosed herein an improvement in the fungicidal compositions. The present invention relates to a fungicide composition based on dithiocarbamate and another fungicide compound and a method for protecting plants against fungal diseases using said composition. The invention also relates to the water-dispersible granular formulations comprising a combination of mancozeb and a copper fungicide for controlling fungal infection such as Downy Mildew Powdery mildew and Anthracnose.

### FIELD OF THE INVENTION

The present invention relates to an improvement in the fungicidal composition. The present invention relates to a fungicide composition based on dithiocarbamate and another fungicide compound and a method for protecting plants against fungal diseases using said composition.

### BACKGROUND OF THE INVENTION

Rice is the world's most important crop and staple food for more than a half of the world's population. Global rice consumption has increased by more than 50 milliontons, with an average annual growth of nearly 2 percent in the past 7 years. India stands first in area, second in production, followed by China (FAO, 2014) [1]. Rice production is affected by several biotic and abiotic constraints; rice blast disease stands out the most disastrous diseases globally affecting rice production. The commonly used management approaches to deal with blast are fungicides.

Fungicides are chemical compounds used to prevent, control or eradicate the spread of fungi on crop or plants in the gardens or in nursery, ornamental plants, etc. This can cause serious damage resulting in the loss of yield and thus quality as well as profit from the crop plants. Fungicides are also used to fight fungal infections. Fungicides can either be contact or systemic fungicides. A contact fungicide kills fungi when sprayed on the infected its surface; and a systemic fungicide has to be absorbed by the plant.

Carbendazim chemically known as methyl benzimidazol-2-ylcarbamate with molecular formula as C9H9N302

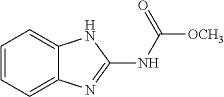 [SMILES: COC(=O)Nc1nc2ccccc2[nH]1]

Carbendazim is a systemic benzimidazole fungicide that plays a very important role in plant disease control. It was first reported in 1973 and was developed by BASF, Hoeschst (now part of Bayer) and Dupont. Pure carbendazim is a colourless, white crystaline, odourless solid which decomposes on melting at approximately 250° C. Technical grade is >98% pure (FAO specification). Carbendazim is not corrosive. Carbendazim is used to control a broad range of diseases on arable crops (cereals, oilseed rape), fruits, vegetables and ornamentals. It is also used in post-harvest food storage, and as a seed pre-planting treatment.

Mancozeb chemically known as [[2-(dithiocarboxy)amino]ethyl] carbamodithioato]](2-)-κS,κS′]manganese mixture with [[2-[(dithiocarboxy)amino]ethyl]carbamodithioato]](2-)-κS,κS′]zinc with molecular formula as:

—SCSNHCH₂CH₂NHCSSMₙ—(Zₙ)

Mancozeb is a dithiocarbamate non-systemic agricultural fungicide with multi-site, protective action on contact. The mixture controls many fungal diseases in a wide range of field crops, fruits, nuts, vegetables, and ornamentals.

As regards fungicide activity, in particular for the protection of crops, various compounds have been applied that shown good fungicide activity. However, the research continues for improvement of performances, in particular in terms of fungicide activity and in particular in terms of maintaining this fungicide activity over time.

Tebuconazole, chemical name (RS)-I-(4-chlorophenyl)-4,4-dimethyl-3-(1H-1,2,4-triazol-1-ylmethyl) pentan-3-ol, the structure of formula (I), is an effective, broad-spectrum, triazole microbicidal fungicide.

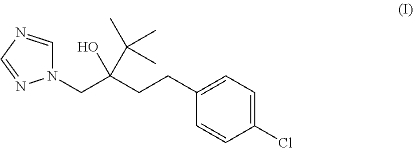 [SMILES: CC(C)(C)C(O)(CCc1ccc(Cl)cc1)Cn1cncn1]

Zineb is the chemical compound with the formula {Zn[S₂CN(H)CH₂CH₂N(H)CS₂]}ₙ. Zineb is a polymeric complex of zinc with the ethylene bis(dithiocarbamate) anionic ligand. It is used as a fungicide to control downy mildews, rusts and redfire disease.

Thiophanate methyl is a member of the benzimidazole group of fungicides. It is a broad spectrum systemic fungicide with protective and curative mode of action. It is absorbed by the leaves and roots. It is effective against a wide range of fungal pathogens including brown spot/septoria leaf blight, pod & stem blight of soybean and powdery mildew of fruits.

Mancozeb is a dithiocarbamate fungicide. It is the zinc ion coordination product with manganese ethylene-1,2-bisdithiocarbamate polymer, having the following chemical structure:

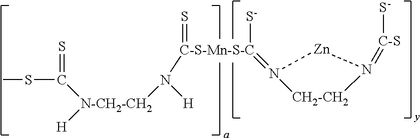

Copper sulphate generates copper ions in an aqueous solution thereof and shows a very strong bactericidal action or effect. Therefore, it has been used as an agricultural chemical over not less than 100 years, while making use of the foregoing characteristic properties. Variety of copper-based fungicides formulations having broad ranges of antibacterial spectrum have been used for controlling crop diseases. However, they have a drawback in that they are less effective for controlling the plant diseases.

The use of fungicide combinations is a widespread and documented practice in the agricultural community. Fungicidal combinations offer significant advantages over individual applications including improved and extended fungal control, reduced fungicide application rates and costs, shorter contact times for improved results, less stringent use restrictions, improved selectivity, improved spectrum of fungi controlled, reduced cost and reduced residue problems.

However, there exists a continuous need in the art for improved compositions that not only helps in controlling the fungal growth but also enhances bioefficacy, having reduced phytotoxicity and an improved stability characteristics and economic significance.

It has been known that application of ‘Carbendazim and Mancozeb’ in the composition, the saprophytic fungi are controlled and due to the plant's undiseased state the nutritional requirement is fulfilled and the biomass of the plants is increased.

Granular formulations offer significant advantages over other formulations such as ease of handling, ease of use, reduced worker exposure, reduced toxicity, and therefore offer a convenient form for delivery of pesticides. These granules flow freely and cleanly from their containers and significantly reduce dust hazards. In order to be effective, the granules are required to maintain their physical integrity until they are delivered to the carrier liquid, where they must disintegrate rapidly into fine particles that can remain suspended in the liquid phase.

Even though the combination of Mancozeb and Carbendazim is known in the art, the same is not known to be synergistically effective in granular formulation combating the fungal diseases.

However, there exists a continuous need in the art for improved compositions that not only helps in controlling the fungal growth but also enhances bioefficacy, having reduced phytotoxicity and an improved stability characteristics and economic significance.

The present invention thus relates to a defined combination of pesticidal active ingredients, and compositions thereof, and methods for using such combinations in the control or prevention of fungal infections in agriculture.

### OBJECTS OF THE INVENTION

The various embodiments of the present invention may, but do not necessarily, achieve one or more of the following advantages and/or objects: An object of the present invention is to provide improved fungicidal composition comprising a dithiocarbamate fungicide and another fungicide.

Another object of the present invention is to provide fungicidal composition comprising a dithiocarbamate fungicide and another fungicide in a synergistic ratio for an efficacious fungal control.

An object of the present invention is to provide improved fungicidal composition comprising a dithiocarbamate fungicide and a benzimidazole fungicide or a benzimidazolylcarbamate fungicide, or a copper fungicide in a solid formulation meant for direct use, useful for combating fungal infections.

Yet another object of the present invention is to provide a solid fungicidal composition comprising a dithiocarbamate fungicide and another fungicide that is useful for effectively controlling one or more fungal infections selected from sheath blight, blast, dirty panicle or brown leaf spot and also enhances the vigor/yield of the plant.

Yet another object of the present invention is to provide a solid fungicidal composition comprising a dithiocarbamate fungicide and a benzimidazole fungicide or a benzimidazolylcarbamate fungicide or a copper fungicide that is useful for effectively controlling sheath blight, blast fungal diseases and also enhances the vigor/yield of the plant, wherein said solid formulation is meant for direct use.

Another object of the present invention is to provide a solid fungicidal formulation which is having good suspensibility and dispersibility.

Yet another preferred object of the present invention is to provide a water dispersible granular formulation comprising mancozeb and copper salt.

Another object of the present invention is to provide a water dispersible granular formulation comprising mancozeb and copper salt having superior antifungal effects.

Yet another object of the present invention is to provide a water dispersible granular formulation of mancozeb and copper salt having an improved and extended fungal control, reduced fungicide application rates and costs, shorter contact times for improved results, less stringent use restrictions, improved selectivity, improved spectrum of fungi controlled, reduced costs, and reduced residue problems.

Another object of the present invention is to provide a water dispersible granular formulation comprising mancozeb and copper salt in a synergistic ratio for an efficacious fungal control.

Yet another advantage of the present invention is to provide a water dispersible granular formulation of mancozeb and copper salt offering several advantages such as ease of handling, ease of use, reduced work exposure, reduced toxicity, reduced spillage and waste disposal, less field drift, free-flow and significant reduction in dust hazards.

Yet another object of the present invention is to provide a water dispersible granular formulation of mancozeb and copper salt having superior attrition resistance without compromising on rapid dispersibility of the formulation and exhibits good suspensivity in water on being dispersed.

These and the other advantages may be realized by reference to the remaining portions of the specification.

### SUMMARY OF THE INVENTION

In an aspect the present invention provides that a fungicidal composition comprising a dithiocarbamate fungicide and another fungicide was synergistic only when presented as a a solid formulation meant for direct use.

In another aspect the present invention provides an improved composition of a dithiocarbamate fungicide and another fungicide in the form of a solid formulation meant for direct use.

In an aspect the present invention provides that a fungicidal composition comprising a dithiocarbamate fungicide and a benzimidazole fungicide or a benzimidazolylcarbamate fungicide or a copper fungicide was synergistic only when presented as a solid formulation meant for direct use.

In another aspect the present invention provides a fungicide composition comprising fungicidally effective amount of a dithiocarbamate fungicide and another fungicide and at least one agriculturally acceptable adjuvant/agriculturally acceptable excipient.

In another aspect the present invention provides a fungicide composition comprising fungicidally effective amount of a dithiocarbamate fungicide and a benzimidazole fungicide or a benzimidazolylcarbamate fungicide or a copper fungicide and at least one agriculturally acceptable adjuvant/agriculturally acceptable excipient.

In another aspect the present invention provides a method for controlling fungi at a locus, said method comprising treating the locus with a composition comprising fungicidally effective amount of a dithiocarbamate fungicide and another fungicide in a solid formulation meant for direct use.

In another aspect the present invention provides a method for controlling fungi at a locus, said method comprising treating the locus with a composition comprising fungicidally effective amount of a dithiocarbamate fungicide and a benzimidazole fungicide or a benzimidazolylcarbamate fungicide or a copper fungicide in a solid formulation meant for direct use.

In another aspect the present invention provides a kit comprising a dithiocarbamate fungicide component and another fungicidal component, wherein the kit comprises at least one component as a solid formulation meant for direct use.

In another aspect the present invention provides a kit comprising a fungicide composition comprising of a dithiocarbamate fungicide and a benzimidazole fungicide or a benzimidazolylcarbamate fungicide by weight of the composition, wherein the kit comprises at least one component comprising the fungicidal composition as a solid formulation meant for direct use.

According to an aspect the present invention provides a water dispersible granular formulation comprising fungicidally effective amounts of mancozeb and copper salt.

In an embodiment, the composition of the present invention comprises mancozeb and copper sulphate in a ratio of about 1:1.5.

In another aspect the present invention provides a formulation comprising mancozeb and copper sulphate in an amount of about 20-50% of each of the active ingredients by weight of the composition.

In another aspect the present invention provides a fungicide composition comprising mancozeb and copper sulphate for controlling the disease downy mildew (Plasmoporaviticola), powdery mildew (Uncinulanecator) and anthracnose (Sphaceloniaamplelinium).

In another aspect the present invention provides a fungicide composition comprising mancozeb and copper sulphate for controlling the disease downy mildew (Plasmoporaviticola), powdery mildew (Uncinulanecator) and anthracnose (Sphaceloniaamplelinium) in grapes.

A water dispersible granular formulation comprising (a) mancozeb; (b) copper sulphate; (c) at least one agriculturally acceptable carrier selected from alkyl naphthalene sulphonate condensate or alkali salts or condensate thereof, sodium naphthalene sulfonate-formaldehyde condensate, polyethyleneglycol mono-[2,4,6-tris(1-phenylethyl] phenyl ether; an alkali metal salt of alkylnaphthalenesulfonate or an alkali metal salt of dioctylsulphosuccinate or a combination thereof.

In another aspect the present invention provides a fungicide composition comprising mancozeb and a copper fungicide selected from copper oxychloride, copper sulfate, copper hydroxide and tribasic copper sulfate (Bordeaux mixture), and at least one agriculturally acceptable carrier/agriculturally acceptable excipient.

In an embodiment, the copper fungicide is copper sulphate.

In an embodiment, the copper fungicide is tribasic copper sulfate.

In another aspect the present invention provides a fungicide composition comprising mancozeb and copper sulphate and at least one agriculturally acceptable carrier/agriculturally acceptable excipient.

In another aspect the present invention provides a method for controlling fungi at a locus, said method comprising treating the locus with a composition comprising mancozeb and a copper fungicide.

In another aspect the present invention provides a kit comprising a fungicide composition comprising mancozeb in an amount of about 25-35% and copper sulphate in an amount of about 40-50% by weight of the composition.

Additional features and advantages of the proposed invention will be apparent from the detailed description that follows, which illustrates by way of example, the most preferred features of the proposed invention which are not to be construed as limiting the scope of the invention described herein.

### DETAILED DESCRIPTION OF THE INVENTION

Unless defined otherwise, all technical and scientific terms used herein have the same meaning as commonly understood by one of ordinary skill in the art to which this invention belongs. It must be noted that, as used in this specification, the singular forms “a,” “an” and “the” include plural referents unless the content clearly dictates otherwise.

The term “about” used to qualify the amounts of mancozeb and carbendazim shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In an embodiment, the aspects and embodiments described herein shall also be interpreted to replace the clause “comprising” with either “consisting of” or with “consisting essentially of” or with “consisting substantially of”.

The term ‘locus’ as used herein shall denote the vicinity of a desired crop in which fungal control is desired. The locus includes the vicinity of desired crop plants wherein the fungal infestation has occurred or is expected to occur. The term crop shall include a multitude of desired crop plants or an individual crop plant growing at a locus.

The term ‘control’ indicates eradication of the investigated fungi. A 100% control signifies total eradication of the fungi under investigation.

The term “fungicidally effective amount” of active components, as used herein, shall denote an amount that can be used to control harmful fungi when used together.

The term “fungicidally effective amount of mancozeb” includes mancozeb being preferably, but not limited to, present in a composition from about 25% to about 35% by weight of the composition. In an embodiment, the term “fungicidally effective amount of mancozeb” includes mancozeb being present in an amount of about 30% by weight of the composition.

The term “fungicidally effective amount of copper sulphate” includes copper sulphate being preferably, but not limited to, present in a composition from about 40% to about 50% by weight of the composition. In an embodiment, the term “fungicidally effective amount of copper sulphate” includes copper sulphate being present in an amount of about 47.15% by weight of the composition.

It has been surprisingly found by the present inventors that a fungicidal combination comprising a dithiocarbamate fungicide and another fungicide was synergistic only when presented as a solid formulation meant for direct use.

It was further found that the fungicidal combination of a dithiocarbamate fungicide and another fungicide was best only additive, and more frequently antagonistic, when presented as a solid formulation meant for dispersion or dissolution.

It has also been surprisingly found by the present inventors that a fungicidal combination comprising a dithiocarbamate fungicide and a benzimidazole fungicide or a benzimidazolylcarbamate fungicide was synergistic only when presented as a solid formulation meant for direct use.

It was further found that the fungicidal combination of a dithiocarbamate fungicide and a benzimidazole fungicide or a benzimidazolylcarbamate fungicide was best only additive, and more frequently antagonistic, when presented as a solid formulation meant for dispersion or dissolution.

Without wishing to be bound by theory, the present inventors believe that when administered as a solid formulation meant for direct use, preferably in granular formulation, the dithiocarbamate fungicide and the second fungicide which can be benzimidazole fungicide or a benzimidazolylcarbamate fungicide interact more intimately thus exhibiting a synergistic correlation, which was not seen in a solid formulation meant for dissolution or dispersion.

In accordance with one aspect of the present invention there is provided an improved fungicidal composition comprising a dithiocarbamate fungicide and at least another fungicide which can be benzimidazole fungicide or a benzimidazolylcarbamate or a copper fungicide, wherein the composition is a solid formulation meant for direct use.

Thus, the present invention provides an improved composition of a dithiocarbamate fungicide and another fungicide which can be benzimidazole fungicide or a benzimidazolylcarbamate or a copper fungicide for controlling fungal disease in plants, wherein the improved composition is a solid formulation meant for direct use.

In an embodiment, the present invention provides a composition comprising:

at least one dithiocarbamate fungicide;

at least one another fungicide; and

at least one agrochemically acceptable excipient;

wherein said composition is a solid formulation meant for direct use.

In an embodiment, the present invention provides a composition comprising:

(a) at least one dithiocarbamate fungicide;

(b) at least one benzimidazole fungicide;

(c) at least one agrochemically acceptable excipient;

wherein said composition is a solid formulation meant for direct use.

In an embodiment, the present invention provides a composition comprising:

(a) at least one dithiocarbamate fungicide;

(b) at least one a benzimidazolylcarbamate fungicide;

(c) at least one agrochemically acceptable excipient;

wherein said composition is a solid formulation meant for direct use.

In an embodiment, the term solid formulation meant for direct use includes the class of solid formulations that is meant for direct use as defined by FAO (http://www.fao.org/3/a-y4353e.pdf, page 72). These formulations are typically in solid form, which are applied in dry form using machines. These are solid formulations applied directly in field without dissolution or dispersion into solvents.

Thus, in an embodiment, the composition of the present invention is a dustable powder (DP), microgranules (MG), wettable granules (WG), powder for dry seed treatment (DS), granules (GR), or a tablet for direct dispersion (DT).

In an embodiment, the composition of the present invention is a granular formulation (GR).

In an embodiment said dithiocarbamate fungicide is selected from group comprising amobam, asomate, azithiram, carbamorph, cufraneb, cuprobam, disulfiram, ferbam, metam, nabam, tecoram, thiram, urbacide, ziram, dazomet etem, milneb, mancopper, mancozeb, maneb, metiram, polycarbamate, propineb and zineb.

In an embodiment said dithiocarbamate fungicide is Zineb.

In another embodiment said dithiocarbamate fungicide is mancozeb.

In an embodiment, the compositions of the present invention comprise at least another fungicide.

In an embodiment, another fungicide is selected from the group comprising a triazole, a strobilurin, a succinate dehydrigenase inhibitor (SDHI), a benzimidazole fungicide or benzimidazole precursor or a benzimidazolyl carbamate fungicide, or a copper fungicide.

In one embodiment, another fungicide is a triazole compound.

In an embodiment the triazole is selected from group of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, or prothioconazole.

In another embodiment another fungicide is strobilurin compound.

In another embodiment, the strobilurin fungicide is selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin or trifloxystrobin.

In another embodiment another fungicide is a succinate dehydrogenase inhibitor (SDHI).

In an embodiment, the succinate dehydrogenase inhibitor is selected from pyrazole carboxamide class of succinate dehydrogenase inhibitor fungicides. However, it should be understood that the choice of succinate dehydrogenase inhibitors is not understood to be limited to these pyrazole carboxamide fungicides alone.

In an embodiment, the pyrazole carboxamide class of succinate dehydrogenase inhibitor fungicide may be selected from benzovindiflupyr, bixafen, fluxapyroxad, furametpyr, isopyrazam, penflufen, penthiopyrad, 3-difluoromethyl-N-(7-fluoro-1, 1, 3-trimethyl-4-indanyl)-1-methyl-4-pyrazolecarboxamide and sedaxane.

In an embodiment, the succinate dehydrogenase inhibitor fungicide may be selected from the group consisting of benodanil, flutolanil, mepronil, isofetamid, fluopyram, fenfuram, carboxin, oxycarboxin, thifluzamide, pydiflumetofen; isofetamid and boscalid.

In another embodiment another fungicide is a benzimidazole.

In an embodiment another fungicide is benzimidazole selected from benomyl, carbendazim (MBC), thiophanate-methyl, fuberidazole and thiabendazole and fuberidazole, albendazole.

In another embodiment another fungicide is a benzimidazole precursor fungicide.

In another embodiment another fungicide is a carbamate fungicide.

In an embodiment benzimidazole precursor fungicide is selected furophanate, thiophanate or thiophanate-methyl.

In another embodiment another fungicide is a copper fungicide which can be copper sulphate.

In an embodiment, the composition of the present invention may further comprise additional fungicides in the combinations of the present invention selected from nucleic acids synthesis inhibitors, cytoskeleton and motor protein inhibitors, amino acids and protein synthesis inhibitors, respiration process inhibitors, signal transduction inhibitors, lipid synthesis and membrane integrity distruptors, sterol biosynthesis inhibitors, melanin synthesis inhibitors, cell wall biosynthesis inhibitors, host plant defence inductors and/or fungicides with unknown modes of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, cypendazole, debacarb and mecarbinzid.fuberidazole, thiabendazole; thiophanates such as thiophanate, thiophanate-methyl; N-phenyl carbamates such as diethofencarb; toluamides such as zoxamide; thiazole carboxamides such as ethaboxam; phenylureas such as pencycuron, benzamides such as fluopicolide; cyanoacrylates such as phenamacril.

In an embodiment, the respiration process inhibitor fungicides may be selected from pyrimidinamines such diflumetorim; pyrazole-5-carboxamides such as tolfenpyrad, strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof; oxazolidine-diones such as famoxadone; Imidazolinones such as fenamidone; benzyl-carbamates such as pyribencarb; N-methoxy-(phenyl-ethyl)-pyrazole-carboxamides such as Pyrimidinamines such as diflumetorim; cyano-imidazole such as cyazofamid; sulfamoyl-triazole such as amisulbrom; dinitrophenyl crotonates such as binapacryl, meptyldinocap, dinocap; 2,6-dinitro-anilines such as fluazinam; pyr.-hydrazones such as ferimzone; tri-phenyl tin compounds such as fentin acetate, fentin chloride, fentin hydroxide; thiophene-carboxamides such as silthiofam; triazolo-pyrimidylamine such as ametoctradin. In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen; quinazolinones such as proquinazid; phenylpyrroles such as fenpiclonil, fludioxonil; dicarboximides such as chlozolinate, dimethachlone, iprodione, procymidone and vinclozolin.

In an embodiment, the fungicide may be selected from lipid synthesis and membrane integrity distruptors such as phosphoro-thiolates such as edifenphos Iprobenfos, pyrazophos; dithiolanes such as isoprothiolane; aromatic hydrocarbons such as biphenyl, chloroneb, dicloran, quintozene (PCNB), tecnazene (TCNB), tolclofos-methyl and the like; 1,2,4-thiadiazoles such as etridiazole; carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine; pyridines such as pyrifenox, pyrisoxazole; pyrimidines such as fenarimol, nuarimol imidazoles such as imazalil, oxpoconazole, pefurazoate, prochloraz, triflumizole; morpholines such as aldimorph, dodemorph, fenpropimorph, tridemorph and the like; piperidines such as fenpropidin, piperalin; spiroketal-amines such as spiroxamine; hydroxyanilides such as fenhexamid; amino-pyrazolinones such as fenpyrazamine; thiocarbamates such as pyributicarb; allylamines such as naftifme, terbinafine and mixtrues thereof. In an embodiment, cell wall biosynthesis inhibitor fungicides may be selected from peptidyl pyrimidine nucleoside fungicides such as polyoxin, cinnamic acid amides such as dimethomorph, flumorph, pyrimorph; valinamide carbamates such as benthiavalicarb, iprovalicarb, valifenalate; mandelic acid amides such as mandipropamid and mixtures thereof.

In an embodiment, melanin synthesis inhibitor fungicide may be selected from isobenzo-furanone such as fthalide; pyrrolo-quinolinones such as pyroquilon; triazolobenzo-thiazoles such as tricyclazole; cyclopropane-carboxamides such as carpropamid; carboxamides such as diclocymet; propionamides such as fenoxanil; trifluoroethyl-carbamates such as tolprocarb; and mixtures thereof.

In an embodiment, host plant defence inductors fungicides may be selected from benzo-thiadiazoles such as acibenzolar-S-methyl; benzisothiazoles such as probenazole; thiadiazole-carboxamides such as tiadinil, isotianil; polysaccharides such as laminarin; and mixtures thereof.

In an embodiment, the additional fungicide is a fungicide with unknown mode of action and may be selected from cyanoacetamide-oximes such as cymoxanil; ethyl phosphonates such as foestyl—Al, phophorous acid and salts; phthalamic acids such as teclofthalam; benzotriazines such as triazoxide; benzene-sulphonamides such as flusulfamide; pyridazinones such as diclomezine; thiocarbamates such as methasulfocarb; phenyl-acetamides such as cyflufenamid; aryl-phenyl-ketones such as metrafenone, pyriofenone; guanidines such as dodine; cyano-methylene-thiazolidines such as flutianil; pyrimidinone-hydrazones such as ferimzone; piperidinyl-thiazole-isoxazolines such as oxathiapiprolin; 4-quinolyl-acetates such as tebufloquin; tetrazolyloximes such as picarbutrazox; glucopyranosyl antibiotics such as validamycin; fungicides such as mineral oil, organic oils, potassium bicarbonate and mixtures thereof.

In an embodiment, the present invention provides a composition comprising:
(a) at least one dithiocarbamate fungicide;
(b) at least one triazole fungicide; and

at least one agrochemically acceptable excipient; wherein said composition is a solid formulation meant for direct use.

In an embodiment, the present invention provides a composition comprising:
(a) at least one dithiocarbamate;
(b) at least one benzimidazole fungicide
(c) at least one agrochemically acceptable excipient

wherein said composition is a solid formulation meant for direct use.

In an embodiment, the present invention provides a composition comprising:
(a) mancozeb;
(b) at least one benzimidazole fungicide
(c) at least one agrochemically acceptable excipient; wherein said composition is a solid formulation meant for direct use.

In an embodiment, the present invention provides a composition comprising:
(a) at least one dithiocarbamate fungicide;
(b) at least one thiophanate fungicide and
(c) at least one agrochemically acceptable excipient;

wherein said composition is a solid formulation meant for direct use.

In an embodiment, the present invention provides a composition comprising:
(a) mancozeb;
(b) at least one a benzimidazolylcarbamate fungicide;
(c) at least one agrochemically acceptable excipient;
wherein said composition is a solid formulation meant for direct use.

In an embodiment, the present invention provides a composition comprising:
(a) zineb;
(b) tebuconazole and
(c) at least one agrochemically acceptable excipient;

wherein said composition is a solid formulation meant for direct use in the granular form.

In an embodiment, the present invention provides a composition comprising:

(a) at least one dithiocarbamate fungicide;

(b) carbendazim; and

(c) at least one agrochemically acceptable excipient;

wherein said composition is a solid formulation meant for direct use in the granular form.

In an embodiment, the present invention provides a composition comprising:
(a) Mancozeb;
(b) thiophanate-methyl; and
(c) at least one agrochemically acceptable excipient;

wherein said composition is a solid formulation meant for direct use in the granular form.

In an embodiment the present invention relates to, a solid formulation meant for direct use, said formulation comprising a combination of at least one dithiocarbamate fungicide and at least one second fungicide selected from a group comprising a triazole, a strobilurin, a succinate dehydrogenase inhibitor (SDHI), a benzimidazole or benzimidazole precursor or a benzimidazole carbamate fungicide, wherein said formulation is a solid formulation meant for direct use.

In an embodiment, the dithiocarbamate fungicide and the second fungicide are present in a synergistic ratio.

In an embodiment the present invention relates to a synergistic solid formulation meant for direct use, said composition comprising combination of zineb and tebuconazole.

In an embodiment, zineb and tebuconazole may be present in a synergistic ratio of 4:1.

In an embodiment the present invention relates to a synergistic solid formulation meant for direct use, said composition comprising combination of mancozeb and thiophanate-methyl.

In an embodiment, mancozeb and thiophanate-methyl may be present in a synergistic ratio of 2:1.

In another embodiment the composition comprises a fungicidally effective amount of Zineb and fungicidally effective amount of tebuconazole, wherein said composition is synergistic when presented as a solid formulation meant for direct use.

In an embodiment the present invention relates to a synergistic solid formulation meant for direct use comprising combination of at least one dithiocarbamate fungicide and at least one benzimidazole fungicide or a benzimidazolylcarbamate fungicide wherein said benzimidazole fungicide or a benzimidazolylcarbamate fungicide and dithiocarbamate fungicide are present in a synergistic ratio of about 1.92:10.08.

In another embodiment the composition comprises a fungicidally effective amount of mancozeb and fungicidally effective amount of cabendazim, wherein said composition is synergistic when presented as a solid formulation meant for direct use.

The term “fungicidally effective amount of mancozeb” includes mancozeb being present in an amount of about 10.08% by weight of the composition.

The term “fungicidally effective amount of carbendazim includes carbendazim being present in an amount of about 1.92% by weight of the composition.

In another embodiment the composition comprises a fungicidally effective amount of mancozeb and fungicidally effective amount of cabendazim, wherein mancozeb and carbendazim are present in a synergistic ratio of about 10.08:1.92.

In another embodiment the composition comprises a fungicidally effective amount of mancozeb and fungicidally effective amount of cabendazim, wherein mancozeb and carbendazim are present in a synergistic ratio of about 10.08:1.92.

The term “fungicidally effective amount of Zineb” includes zineb being present in an amount of about 57% by weight of the composition.

The term “fungicidally effective amount of tebuconazole” includes tebuconazole being present in an amount of about 15% by weight of the composition.

The term “fungicidally effective amount of mancozeb” includes mancozeb being present in an amount of about 50% by weight of the composition.

The term “fungicidally effective amount of thiophanate-methyl includes thiophanate-methyl being present in an amount of about 25% by weight of the composition.

In another embodiment the composition comprises a fungicidally effective amount of zineb and fungicidally effective amount of tebuconazole, wherein zineb and tebuconazole are present in a synergistic ratio of about 4:1.

In another embodiment the composition comprises a fungicidally effective amount of mancozeb and fungicidally effective amount of thiophanate-methyl, wherein mancozeb and thiophanate-methyl are present in a synergistic ratio of about 2:1.

In an embodiment, these compositions are in the form of a solid composition meant for direct use.

Preferably however, the specific amounts of mancozeb and thiophanate-methyl present within the compositions of the present invention is not particularly limiting as long as the ratio of about 2:1 is maintained. This preferred ratio is meant to be particularly preferred, although other ratios are not excluded.

Preferably however, the specific amounts of zineb and tebuconazole present within the compositions of the present invention is not particularly limiting as long as the ratio of about 4:1 is maintained. This preferred ratio is meant to be particularly preferred, although other ratios are not excluded.

In an exemplary embodiment, which is not to be construed as limiting, mancozeb is present in an amount of about 50% by weight of the composition and thiophanate-methyl is present in an amount of about 25% by weight of the composition.

Preferably however, the specific amounts of mancozeb and carbendazim present within the compositions of the present invention is not particularly limiting as long as the ratio of about 10.08:1.92 is maintained. This preferred ratio is meant to be particularly preferred, although other ratios are not excluded.

In an exemplary embodiment, which is not to be construed as limiting, mancozeb is present in an amount of about 10.08% by weight of the composition and carbendazim is present in an amount of about 1.92% by weight of the composition.

In an exemplary embodiment, which is not to be construed as limiting, zineb is present in an amount of about 57% by weight of the composition and tebuconazole is present in an amount of about 15% by weight of the composition.

In an embodiment the present invention provides a synergistic composition comprising zineb and tebuconazole characterized in that the composition is formulated as a solid formulation meant for direct use.

In an embodiment the present invention provides a synergistic composition comprising mancozeb and thiophanate-methyl characterized in that the composition is formulated as a solid formulation meant for direct use.

In an embodiment the present invention provides a synergistic composition comprising carbendazim and mancozeb characterized in that the composition is formulated as a solid formulation meant for direct use.

In yet another embodiment, the invention provides water dispersible granular formulation comprising a dithiocarbamate fungicide and copper salt for plant disease control and method of controlling plant disease using said composition.

According to an aspect the present invention there is provided a water dispersible granular formulation comprising mancozeb and a copper fungicide, which exhibits excellent effects of controlling crop diseases, particularly downy mildew, powdery mildew and anthracnose in grapes.

Therefore, the present invention provides a composition comprising mancozeb and a copper fungicide, wherein mancozeb and copper fungicide are present in a ratio of about 1:1.5.

In an embodiment, the copper fungicide may be selected from copper oxychloride, copper sulfate, copper hydroxide and tribasic copper sulfate (Bordeaux mixture).

In another aspect the present invention provides a fungicide composition comprising mancozeb in an amount of about 25-35% and a copper fungicide in an amount of about 40-50% by weight of the composition.

In an embodiment the fungicide composition comprising mancozeb in an amount of about 30% by weight of the formulation and copper sulphate in an amount of about 47.15% by weight of the formulation.

It has been surprisingly found that (a) the combination of mancozeb and copper fungicide elicited faster fungicidal activity than either fungicide alone; (b) the combination of mancozeb and copper fungicide resulted in greater increase in the fungicidal activity than the additive effects of mancozeb and copper sulphate alone; and (c) combining lipid metabolism disruptor mancozeb with signal transduction inhibitor copper fungicides led to a greater than additive fungicidal activity, which is an evidence of synergistic fungicidal potentiation.

In another aspect the present invention provides a fungicide composition comprising mancozeb and a copper fungicide for controlling the disease downy mildew (Plasmoporaviticola), powdery mildew (Uncinulanecator) and anthracnose (Sphaceloniaamplelinium).

In another aspect the present invention provides a fungicide composition comprising mancozeb and a copper fungicide and at least one agriculturally acceptable carrier/agriculturally acceptable excipient.

In an embodiment, the wettable granular formulation of each or any aspect or embodiment described hereinabove comprises at least one carrier selected from at least one wetting agent, at least one antifoam, at least one stabilizing agent, at least one pH modifier, at least one surfactant and combinations thereof. The formulation content of these carriers is not particularly limiting and may be determined by a skilled technician in the art according to the conventional protocols.

In one embodiment, the formulation may contain ionic and nonionic dispersing agents to enable disintegration of granules in water with ease, such as salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates. The preferred dispersing agents include sodium naphthalene sulfonate-formaldehyde condensate, polyethyleneglycol mono-[2,4,6-tris (1-phenylethyl] phenyl ether or a combination thereof.

In one embodiment, the formulation may contain stabilizers. Such stabilizers may include carboxylic acids, such as citric acid and butenedioic acid or inorganic components such as sodium hydroxide, potassium hydroxide, and sodium dihydrogen phosphate dihydrate which may also act as a pH modifier.

In a preferred embodiment, the formulation of the present invention comprises a wetting component comprising a wetting blend selected from an alkali metal salt of alkylnaphthalenesulfonate or an alkali metal salt of dioctylsulphosuccinate or a combination thereof.

In an embodiment, the formulations of the present invention comprise at least one antifoaming agent which are usually employed for this purpose in agrochemical compositions. In an embodiment, the preferred antifoaming agents are selected from silicone oil and magnesium stearate or a suitable combination thereof.

In an embodiment, the formulations of the present invention comprise at least one pH modifier selected from organic and inorganic components that are usually employed in agrochemical compositions to modify the pH. In a non-limiting embodiment, the pH modifier may be selected from potassium carbonate, potassium hydroxide, sodium hydroxide and sodium dihydrogen phosphate. However, the choice of a pH modifier is not particularly limiting.

In an embodiment, the formulations of the present invention comprise at least one further surfactant selected from salts of polystyrenesulphonic acids; salts of polyvinylsulphonic acids; salts of naphthalenesulphonic acid/formaldehyde condensates; salts of condensates of naphthalenesulphonic acid, phenolsulphonic acid and formaldehyde; salts of lignosulphonic acid; polyethylene oxide/polypropylene oxide block copolymers; polyethylene glycol ethers of linear alcohols; reaction products of fatty acids with ethylene oxide and/or propylene oxide; polyvinyl alcohol; polyvinylpyrrolidone; copolymers of polyvinyl alcohol and polyvinylpyrrolidone; copolymers of (meth)acrylic acid and (meth)acrylic esters; and alkyl ethoxylates and alkylarylethoxylates.

The fungicidal combination of the present invention is preferably formulated as a solid formulation including, but not limited to, dust, powder, granules, pellets, tablets, wettable granules (WG), microgranules (MG), dry flowable, wettable powder or water dispersible granules (wettable granules).

The fungicidal combination of the present invention is preferably formulated as a water dispersible granule (wettable granules).

In an embodiment, the formulation of the present invention is a wettable granular formulation, wherein the active ingredients are combined with various carriers.

Therefore, in this aspect, the present invention provides a wettable granular formulation comprising mancozeb in an amount of about 30% w/w by total weight of the formulation and copper sulphate in an amount of about 47% w/w by total weight of the formulation. These carriers may be organic or inorganic material which may be combined with the active ingredients so as to facilitate better spreadability as well as enable better contact with the target fungi. These carriers must be agriculturally acceptable and environmentally friendly. Carriers may include such dispersing agents, stabilizers, antifoaming agents, pH modifiers, surfactants, and other fillers which may be added in into a stable formulation. However, the present inventors found that the preparation of a granular formulation comprising mancozeb and copper sulphate in a predetermined weight percentage is not straightforward and is plagued by many problems. A wettable granular formulation comprising mancozeb and copper sulphate wherein the formulation displays superior antifungal properties is provided.

In another aspect the present invention provides a method for controlling fungi at a locus, said method comprising treating the locus with a composition comprising mancozeb and a copper fungicide.

The formulation of the present invention maintains or increases the fungicidal activity of mancozeb and is more persistent in the field.

In an embodiment, the composition comprising mancozeb and a copper fungicide are particularly useful for controlling of Downy Mildew (Plasmoporaviticola), powdery mildew (Uncinulanecator) and anthracnose (Sphaceloniaamplelinium) in Grape crop.

In another aspect the present invention provides a process for preparation of synergistic composition of present invention.

The process for preparation of synergistic composition comprising:
(a) dry milling a copper fungicide, optionally in the presence of mancozeb or at least one agrochemically acceptable carrier;
(b) blending fungicidally effective amounts of pre-milled copper fungicide and mancozeb with water;
(c) spray drying the resultant slurry at predetermined inlet and outlet temperatures of the dryer to obtain dried granules.

The formulation described above is a fungicidally efficacious and stable formulation.

The term “wet milling” as used herein is intended to mean the grinding of materials with a sufficient quantity of a liquid to form a slurry. The process of wet milling and apparatus therefore are conventionally known in the art and do not form a critical feature of the present invention.

The process step of “spray drying” is conventionally known in the art. The conventional process for spray drying generally involves concentrating the input slurry, atomization of the slurry, droplet-hot gas contacting, evaporative drying of the droplets and separation of the spray dried granules. It was found that the spray-dried product according to the present invention possessed improved flow properties, better distribution of the active ingredients within the granules and required less dispersing agent(s) than the wet bead milled formulation.

The formulation described above is a fungicidally efficacious and stable formulation. Also, the granules obtained by the process have superior attrition resistance, disperses rapidly in water and have good suspensibility in water once it is dispersed.

The formulation also demonstrates reduced toxicity, reduced use rates, lesser damage to the environment, as well as reduction in dust hazard.

In another aspect, the present invention provides a method of treating a fungal infestation at a locus by treating said locus with a composition comprising mancozeb and a copper fungicide.

In an embodiment, the method comprises treating a fungal infection at a locus by treating the locus with a composition comprising mancozeb and a copper fungicide.

In another aspect, the compositions of the present invention may be presented in the form of a multi-pack fungicidal product or as a kit-of-parts for fungicidal treatment of plants.

In an embodiment the dry flowable or water degradable granules of the present invention may be packaged as a kit of parts, wherein, the pre-formulated granules, which may be readily mixed with water, or in an embodiment, the kit of parts may contain such components such as a vial, bottle, can, pouch, bag or canister.

The present invention provides a kit-of-parts for fungicidal treatment of plants, its habitat, a crop field, the soil or any material thereabout, said kit-of-parts comprising: fungicidally effective amount, about 30% of mancozeb and about 47% of copper sulphate and an instruction manual comprising instructions for using and treating the plants, its habitat, a crop field, the soil or any material thereabout with said composition.

The formulations of the present invention display an improved and extended fungal control, reduced fungicide application rates and costs, shorter contact times for improved results, less stringent use restrictions, improved selectivity, improved spectrum of fungi controlled, reduced costs, and reduced residue problems.

### Advantages of One or More Embodiments of the Present Invention

1. The present invention provides a combination of manozeb and a copper fungicide at a synergistic amount.
2. The compositions according to the present invention possess an improved dispersibility and suspensibility.
3. The compositions of the present invention display an improved and extended fungal control, reduced fungicide application rates and costs, less stringent use restrictions, improved selectivity, improved spectrum of fungi controlled, reduced costs, and reduced residue problems.
4. The water dispersible granular composition of mancozeb and a copper fungicide according to the invention possess superior attrition resistance without compromising on rapid dispersibility of the formulation and exhibits good suspensivity in water on being dispersed.

The compositions according to the present invention are effective for the following plant diseases:

Disease in rice: Blast (Pyricularia Oryzae), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch 3h, (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust—(Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium 3h, haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis) tA Phytophthora rot (Phytophthora sp.), and damping-off (Pythium sp.).

Diseases of tomato: early blight (Alternaria solani), leaf mold (Cladosporium fulvum), and late blight (Phytophthora infestans).

Diseases of eggplant: brown spot (Phomopsis vexans), and powdery mildew 3 (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor).

Diseases of soybean: purple seed stain (Cercospora kikchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and -Rhizoctonia damping-off (Rhizoctonia solani).

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora tA infestans), pink rot (Phytophthora erythroseptica), and powdery scab (Spongospora subterranean f. sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe 3 leucospila), gray blight (Pestalotiopsis sp.), and anthracnose (Colletotrichumtheae sinensis).

Diseases of tobacco: brown spot (Alternaria longipes), powdery mildew (Erysiphe cichoracearum), anthracnose (Colletotrichum tabacum), downy mildew 4h, (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beat: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

A Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka 4h, (Mycosphaerella musicola).

Disease of sunflower: downy mildew (Plasmopara halstedii).

Seed diseases or diseases in the early stages of the growth of various plants caused—by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

In an embodiment the solid formulation comprising a combination of mancozeb and carbendazim in a synergistic ratio is provided for controlling disease in rice preferably Blast (Pyricularia oryzae), Helminthosporium leaf spot (Cochliobolus miyabeanus), sheath blight (Rhizoctonia solani), and bakanae disease (Gibberella fujikuroi).

In an embodiment the solid formulation of the present invention is provided for controlling plant diseases selected from Blast (Pyricularia oryzae) and sheath blight (Rhizoctonia solani).

In another embodiment the solid formulation of the present invention is provided for controlling Blast (Pyricularia oryzae).

In another embodiment the solid formulation of the present invention is provided for controlling sheath blight (Rhizoctonia solani).

The compositions of the present invention can be used in agricultural lands such as fields, paddy fields, lawns and orchards or in non-agricultural lands. The present invention may be used to control diseases in agricultural lands for cultivating the plants without any phytotoxicity to the plant.

The compositions of the present invention did not show any sign or symptoms of any phytotoxicity and proved safe at different growth stages of plants.

Examples of the crops on which the present compositions can be used include but are not limited to corn, rice, wheat, barley, rye, oat, sorghum, cotton, soybean, peanut, buckwheat, beet, rapeseed, sunflower, sugar cane, tobacco, groundnut, chilli etc.; vegetables: solanaceous vegetables such as eggplant, tomato, pimento, pepper, A potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum,—nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In most preferred embodiment, the present invention relates to a solid formulation meant for direct use comprising Carbendazim and Mancozeb that enables not only a simultaneous reduction of fungal diseases in the crop plant, grain, fruits and vegetable field and but also enhancing the crop yield.

In an embodiment, the composition further comprises filler selected from a group consisting of silica, kaoline, and clay.

In an embodiment, the composition further comprises stabilizing dye for example Stabmet XE Blue (SXB), a stabilized copper phthalocyanine pigment.

The compositions of the present invention further comprise an agriculturally acceptable carriers or excipient or adjuvants. These adjuvants may be organic or inorganic material which may be combined with the active ingredients so as to facilitate better spreadability as well as enable better contact with the target fungi. These carriers are agriculturally acceptable and environmentally friendly. Adjuvants may include such dispersing agents, antifoaming agents, pH modifiers, surfactants, stabilizers and other fillers which may be added into a composition.

In an embodiment of the present invention, the agrochemical composition may further comprise one or more agriculturally acceptable carriers selected from antifreeze agent, wetting agents, fillers, surfactants, anticaking agents, pH-regulating agents, preservatives, biocides, antifoaming agents, colorants and other formulation aids.

The composition content of these carriers is not particularly limiting and may be determined by a skilled technician in the art according to the conventional protocols.

In one embodiment, the composition may contain ionic and nonionic dispersing agents to enable disintegration of granules in water with ease, such as salts of polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates. The preferred dispersing agents include sodium naphthalene sulfonate-formaldehyde condensate, alkyl naphthalene sulfonate or a combination thereof. The dispersing agent is present in an amount of 2-20% w/w.

In an embodiment, the compositions of the present invention comprise at least one wetting agent selected from soaps; salts of aliphatic monoesters of sulphuric acid including but not limited to sodium lauryl sulphate; sulfoalkylamides and salts thereof including but not limited to N-methyl-N-oleoyltaurate Na salt; alkylarylsulfonates including but not limited to alkylbenzenesulfonates; alkylnaphthalenesulfonates and salts thereof and salts of ligninsulfonic acid. In an embodiment, the wetting agent includes a blend comprising an alkali metal salt of alkylnaphthalenesulfonate or an alkali metal salt of ligninsulfonic acid or a combination thereof. The wetting agent is present in an amount of 0.1 to 10% w/w.

In a preferred embodiment, the composition of the present invention comprises a wetting component comprising a wetting blend selected from an alkali metal salt of alkylnaphthalenesulfonate or an alkali metal salt of ligninsulfonic acid or a combination thereof.

In an embodiment, the compositions of the present invention comprise at least one pH modifier selected from organic and inorganic components that are usually employed in agrochemical compositions to modify the pH. In a non-limiting embodiment, the pH modifier may be selected from potassium carbonate, potassium hydroxide, sodium hydroxide and sodium dihydrogen phosphate. However, the choice of a pH modifier is not particularly limiting. The pH modifier is present in an amount of 0.1-2.0% w/w.

In an embodiment, the compositions of the present invention comprise at least one further antifoams and defoamers based on silicone, particularly preferred are polysiloxanes or alkali polysiloxane.

The antifoams/defoamers are added in an amount from about 0.01% to about 2% w/w, preferably from about 0.1% to about 1.5% w/w of total weight of the agrochemical composition.

In an embodiment, the compositions of the present invention comprise at least one surfactant selected from salts of polystyrenesulphonic acids; salts of polyvinylsulphonic acids; salts of naphthalenesulphonic acid/formaldehyde condensates; salts of condensates of naphthalenesulphonic acid, phenolsulphonic acid and formaldehyde; salts of lignosulphonic acid such as the group comprising alkyl and aryl sulfates and sulfonates, including sodium lignosulphonate; polyethylene oxide/polypropylene oxide block copolymers; polyethylene glycol ethers of linear alcohols; reaction products of fatty acids with ethylene oxide and/or propylene oxide; polyvinyl alcohol; polyvinylpyrrolidone; copolymers of polyvinyl alcohol and polyvinylpyrrolidone; copolymers of (meth)acrylic acidalky] sulfates, sodium mono- and (meth)acrylic esters; di-alkyl naphthalene sulfonates, sodium alpha-olefin sulfonate, lignin and alkyl ethoxylates its derivatives (such as lignosulfonate salts), sodium alkane sulfonates, polyoxyalkyene alkylether sulfate, polyoxyalkylene alkylaiyl ether sulfates, polyoxy-alkylene styrylphenyl ether sulfate, mono- and alkylarylethoxylates. The di-alkylbenzene sulfonates, alkylnaphthalene sulfonate, alkylnaphthalene sulfonate formaldehyde condensate, alkyl diphenylether sulfonates, olefme sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates, anionic fluorosurfactants, amid ether sulfates, N-methyl fatty acid taurides, mixtures thereof and the like, including sodium, potassium, ammonium and amine salts, etc. or mixtures thereof.

In an embodiment the surfactant is present in an amount of 0.1 to 25% w/w. of the total weight of the agrochemical composition.

In another aspect the present invention provides a process for preparation of synergistic composition of present invention.

The process comprises the steps of: 1) Mixing all the ingredients in required quantity in a blender to have Pre-blended mixture in the form of homogenous powder; 2) Micronize/grind the preblended mixture through a suitable micronizer. This micronized material is later post-mixed to have homogenous powder; 3) Admixing water, with the post-mixed mixture, to obtain the homogenous wet dough; 4) granulating the dough to obtain granules and 5) drying and sieving the granules through desired sieves and 6) packing the dried granules.

The formulation described above is a fungicidally efficacious and stable formulation.

In an embodiment, the combination product of “Carbendazim, Mancozeb” and “Tebuconazole, Zineb” is found effective in controlling the fungal diseases in paddy, wheat, black gram, chilli, and tomato. The commonly observed fungal diseases in these crops are sheath blight, sheath rot, brown spot of rice, blast of rice, root rot, leaf rust, stem rust, alternaria leaf blight, cercospora leaf spot, powdery mildew, corynespora leaf spot, rust, anthracnose, cercospora leaf spot, alternaria leaf spot, die back of chilli, anthracnose, powdery mildew, septoria leaf blight, anthracnose, early blight, late blight, fusarium wilt which are successfully controlled by the combination product of “Tebuconazole, Zineb”. The invention disclosed in this specification is not limited to these crops and diseases but can also extended to the crops or diseases known to the person skilled in the art.

In an embodiment, the combination product of “Thiophanate methyl, Mancozeb” is found effective in controlling the fungal diseases in paddy, wheat, black gram, chilli, and tomato. The commonly observed fungal diseases in these crops are sheath blight, sheath rot, brown spot of rice, blast of rice, root rot, leaf rust, stem rust, alternarial leaf blight, cercospora leaf spot, powdery mildew, corynespora leaf spot, rust, anthracnose, cercospora leaf spot, alternaria leaf spot, die back of chilli, anthracnose, powdery mildew, septoria leaf blight, anthracnose, early blight, late blight, fusarium wilt which are successfully controlled by the combination product of “Thiophanate methyl, Mancozeb and Carbendazim, Mancozeb”. The invention disclosed in this specification is not limited to these crops and diseases but can also extended to the crops or diseases known to the person skilled in the art.

In another aspect the present invention provides a method for controlling fungi at a locus, said method comprising treating the locus with a composition comprising fungicidally effective amount of a dithiocarbamate fungicide and, tebuconazole, wherein said composition is a solid formulation meant for direct use.

In another aspect the present invention provides a method for controlling fungi at a locus, said method comprising treating the locus with a composition comprising fungicidally effective amount of a benzimidazole fungicide or a benzimidazolylcarbamate fungicide wherein said composition is a solid formulation meant for direct use.

In an embodiment, the present invention provides a method for controlling fungi at a locus, said method comprising treating the locus with a composition comprising fungicidally effective amount of zineb and tebuconazole, wherein said composition is a solid formulation meant for direct use.

In an embodiment, the present invention provides a method for controlling fungi at a locus, said method comprising treating the locus with a composition comprising fungicidally effective amount of mancozeb and carbendazim in a solid formulation meant for direct use.

In another aspect the present invention provides a method for controlling fungi at a locus, said method comprising treating the locus with a composition comprising fungicidally effective amount of a dithiocarbamate fungicide and thiophanate methyl, wherein said composition is a solid formulation meant for direct use.

In another aspect the present invention provides a method for controlling fungi at a locus, said method comprising treating the locus with a composition comprising fungicidally effective amount of Mancozeb and thiophanate methyl, wherein said composition is a solid formulation meant for direct use.

In another aspect the present invention provides a kit comprising a dithiocarbamate fungicide component and a second fungicide component comprising one of a triazole compound, or a strobilurin fungicide, or a benzimidazole fungicide or a benzimidazolylcarbamate fungicide, wherein the kit comprises at least one component at least one of these fungicides as a solid formulation meant for direct use.

In another aspect the present invention provides a kit comprising a fungicide composition comprising of a dithiocarbamate fungicide and a benzimidazole fungicide or a benzimidazolylcarbamate fungicide, wherein the kit comprises at least one component comprising these fungicides as a solid formulation meant for direct use.

In an embodiment, the present invention provides a kit comprising a fungicide composition containing mancozeb and carbendazim in a synergistic amount wherein said composition is formulated as a solid formulation meant for direct use.

However, it should be understood that the scope of the present invention is not limited by the examples in any manner. It will be appreciated by any person skilled in this art that the present invention includes aforesaid examples and further can be modified and—altered within the technical scope of the present invention.

While the foregoing written description of the invention enables one of ordinary skill to make and use what is considered presently to be the best mode thereof, those of ordinary skill will understand and appreciate the existence of variations, its combinations, and equivalents of the specific embodiment, method, and examples herein. The invention should therefore not be limited by the above described embodiment, method, and examples, but by all embodiments and methods within the scope and spirit of the invention.

The invention will be illustrated with reference to the following examples.

### EXAMPLES

### Example 1a

### Composition of Mancozeb and Thiophanate Methyl

| Ingredients | Amount (%) w/w) |
|---|---|
| Mancozeb | 50 |
| Thiophanate methyl | 25 |
| Sodium alkyl naphthalene | 3 |
| sulphonate | |
| Sodium lignosulphonate | Q.S. |
| | 100.00 |

### Example 1b

### Preparation of Synergistic Combination of Mancozeb and Carbendazim

| Ingredients | Amount (%) |
|---|---|
| Mancozeb | 10.08 |
| Carbendazim | 1.92 |
| clay | 8.00 |
| Kaolin | QS |
| | 100.00 |

Process of Manufacture of Granular Formulation:

The process involves following steps:

1) Mixing:

All the ingredients were mixed in required quantity in a blender to have Pre-blended mixture in the form of homogenous powder.

2) Micronizing and post mixing:—

The preblended mixture was micronize/grinded through a suitable micronizer. This micronized material was later post-mixed to have homogenous powder.

3) Dough preparation/Wet mixing:—

Water was admixed with the post-mixed mixture (obtained in step 2 above), to obtain the homogenous wet dough.

4) Granulation/Extrusion:—

The dough obtained in step 3 was granulated to obtain the granules.

5) Drying:

The granules obtained in step 5 were dried such that the moisture content in the dried granules should be below 3.0% by mass.

6) Sieving:

The granules obtained in step 5 were sieved through desired sieves and packed in desired pack.

### Example 2

### Composition of Zineb and Tebuconazole

| Ingredients | Amount (% w/w) |
|---|---|
| Zineb | 57 |
| Tebuconazole | 15 |
| Naphthalene sulphonic acid | 4 |
| formaldehyde condensate, sodium | |
| salt | |
| Sodium lignosulphonate | Q.S. |
| | 100.00 |

Field Trials:

Treatment with composition of present invention was given to crops in different season and evaluated the disease control.

Percentage of disease control with the composition of the present invention was calculated using Colby equation.

The following equation was used to calculate the expected activity of mixtures containing two active ingredients, for example A and B:

Expected=A+B−(A×B/100)

A=observed efficacy of active component A at the same concentration as used in the mixture;

B=observed efficacy of active component B at the same concentration as used in the mixture.

Treatments evaluated, application rate employed, pathogens evaluated and resulting disease control are presented in the following Tables.

TABLE 1
Season I
Disease—Paddy Blast

| | | | Expected | Difference |
|---|---|---|---|---|
| | | | Percentage | between |
| | | | Control | observed and |
| | Formulation | Percentage | calculated by | expected |
| | dose (Kg or | Control | Colby's | Control; |
| Treatment | L/ha) | (Observed) | formula | Conclusion |
| Mancozeb | 2.0 | 33.33 | — | — |
| 75% WP | | | | |
| Canbendazim | 0.5 | 54.91 | — | — |
| 50% WP | | | | |
| Carbendazim | 0.75 | 69.18 | — | — |
| 12% + | | | | |
| Mancozeb | | | | |
| 63% WP | | | | |
| Colby's formula calculation: | | | 69.93 | +0.75; |
| | | | | Additive |
| UPF 409 | 12.5 | 72.24 | — | — |
| Colby's formula calculation: | | | 69.93 | +2.31; |
| | | | | Synergistic |
| UPF 409 | 15.0 | 73.60 | | |
| Colby's formula calculation: | | | 69.93 | +3.67; |
| | | | | Synergistic |

Paddy Sheath Blight

| | | | | |
|---|---|---|---|---|
| Mancozeb | 2.0 | 21.31 | — | — |
| 75% WP | | | | |
| Canbendazim | 0.5 | 37.00 | — | — |
| 50% WP | | | | |
| UPF 409 | 12.5 | 72.24 | 50.43 | +21.81; |
| | | | | Synergistic |
| UPF 409 | 15.0 | 73.60 | 50.43 | +23.17; |
| | | | | Synergistic |

TABLE 2
Season II
Disease—Sheath Blight

| | | | Percentage | Difference |
|---|---|---|---|---|
| | | | control | between |
| | | | Expected | observed and |
| | Formulation | Percentage | calculated by | expected |
| | dose (Kg or | Control | Colby's | Control; |
| Treatment | L/ha) | (Observed) | formula | Conclusion |
| Mancozeb | 2.0 | 27.80 | — | — |
| 75% WP | | | | |
| Canbendazim | 0.5 | 36.82 | — | — |
| 50% WP | | | | |
| Carbendazim | 0.75 | 52.39 | — | — |
| 12% + | | | | |
| Mancozeb | | | | |
| 63% WP | | | | |
| Colby's formula calculation: | | | 54.38 | −1.99; Not |
| | | | | synergistic |
| UPF 409 | 12.5 | 64.58 | — | — |
| Colby's formula calculation: | | | 54.38 | +10.20; |
| | | | | Synergistic |
| UPF 409 | 15.0 | 66.59 | | |
| Colby's formula calculation: | | | 54.38 | +12.21; |
| | | | | Synergistic |

TABLE 3
Season III (Comparative)
Disease—Paddy Sheath Blight

| | | | Percentage | Difference |
|---|---|---|---|---|
| | | | Control | between |
| | | | Expected | observed and |
| | Formulation | Percentage | calculated by | expected |
| | dose (Kg or | Control | Colby's | Control; |
| Treatment | L/ha) | (Observed) | formula | Conclusion |
| Mancozeb 75% | 2.0 | 45.12 | — | — |
| WP | | | | |
| Canbendazim | 0.5 | 58.80 | — | — |
| 50% WP | | | | |
| Carbendazim | 0.75 | 76.87 | — | — |
| 12% + | | | | |
| Mancozeb 63% | | | | |
| WP | | | | |
| Colby's formula calculation: | | | 90.47 | −13.6; Not |
| | | | | synergistic |

TABLE 4
Season IV
Disease-Paddy Blast

| | | | Percentage | Difference |
|---|---|---|---|---|
| | | | Control | between |
| | | | Expected | observed and |
| | Formulation | Percentage | calculated by | expected |
| | dose (Kg or | Control | Colby's | Control; |
| Treatment | L/ha) | (Observed) | formula | Conclusion |
| Mancozeb | 2.0 | 19.66 | — | — |
| 75% WP | | | | |
| Canbendazim | 0.5 | 36.61 | — | — |
| 50% WP | | | | |
| Colby's formula calculation: | | | 49.07 | — |
| UPF 409 | 12.5 | 58.94 | — | +9.97; |
| | | | | Synergistic |
| UPF409 | 15.0 | 62.02 | — | +12.95; |
| | | | | Synergistic |

TABLE 5
Bioefficacy against the brown spot disease complex of paddy crop during
Season 1

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby' s | Control; |
| Treatment | mL/ha) | (Observed) | formula | Conclusion |
| Mancozeb | 1000 | 28.7 | — | — |
| 75% WP | | | | |
| Thiophanate- | 535.7 | 31.7 | — | — |
| methyl 70% | | | | |
| WP | | | | |
| Mancozeb + | 750 + 375 | 69.7 | — | — |
| Thiophanate- | | | | |
| methyl WG | | | | |
| Colby's formula calculation: | | | 51.3 | +18.4; |
| | | | | Synergistic |

TABLE 6
Bioefficacy against the sheath blight disease complex of paddy crop during Season 2

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby's | Control; |
| Treatment | mL/ha) | (Observed) | formula | Conclusion |
| Mancozeb | 1000 | 3.6 | — | — |
| 75% WP | | | | |
| Thiophanate- | 535.7 | 64.0 | — | — |
| methyl 70% WP | | | | |
| Mancozeb + | 750 + 375 | 76.3 | — | — |
| Thiophanate- | | | | |
| methyl WG | | | | |
| Colby's formula calculation: | | | 65.3 | +11.0; |
| | | | | Synergistic |

TABLE 7
Bioefficacy against the brown spot disease complex of paddy crop during Season 2

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby's | Control; |
| Treatment | mL/ha) | (Observed) | formula | Conclusion |
| Mancozeb | 1000 | 36.5 | — | — |
| 75% WP | | | | |
| Thiophanate- | 535.7 | 39.4 | — | — |
| methyl 70% WP | | | | |
| Mancozeb + | 750 + 375 | 74.0 | — | — |
| Thiophanate- | | | | |
| methyl WG | | | | |
| Colby's formula calculation: | | | 61.5 | +12.5; |
| | | | | Synergistic |

TABLE 8
Bioefficacy against the brown spot disease complex of paddy crop during Season 1

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby's | Control; |
| Treatment | mL/ha) | (Observed) | formula | Conclusion |
| Mancozeb | 1000 | 28.7 | — | — |
| 75% WP | | | | |
| Thiophanate- | 535.7 | 31.7 | — | — |
| methyl 70% WP | | | | |
| Mancozeb + | 750 + 375 | 69.7 | — | — |
| Thiophanate- | | | | |
| methyl WG | | | | |
| Colby's formula calculation: | | | 51.3 | +18.4; |
| | | | | Synergistic |

TABLE 9
Bioefficacy against leaf spot of chilly crop during Season 1-10 days after 2^{nd} spray

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby's | Control; |
| Treatment | mL/ha) | (Observed) | formula | Conclusion |
| Zineb 75% | 750 | 1.4 | — | — |
| WP | | | | |
| Tebuconazole | 187.5 | 31.4 | — | — |
| 29.5% EC | | | | |
| Tebuconazole + | 187.5 + 712.5 | 63.6 | — | — |
| Zineb WG | | | | |
| Colby's formula calculation: | | | 32.4 | +31.2; |
| | | | | Synergistic |

TABLE 10
Bioefficacy against the Chaenophora blight disease of chilly crop during Season 1

| | | | Percentage | Difference |
|---|---|---|---|---|
| | | | control | between |
| | | Percentage | Expected | observed and |
| | Formulation | Control of | calculated by | expected |
| | dose (g or | sheath blight | Colby's | Control; |
| Treatment | mL/ha) | (Observed) | formula | Conclusion |
| Zineb 75% | 750 | 15.73 | — | — |
| WP | | | | |
| Tebuconazole | 187.5 | 58.6 | — | — |
| 25.9% EC | | | | |
| Tebuconazole + | 187.5 + 712.5 | 68.8 | — | — |
| Zineb | | | | |
| Colby's formula calculation: | | | 65.0 | +3.8; |
| | | | | Synergistic |

TABLE 11
Bioefficacy on leaf spot disease of chilli under field condition in Rabi 1^{st} year

| | | | | |
|---|---|---|---|---|
| | | | | Difference between |
| | | | Percentage control | observed and |
| | Formulation | | Expected | expected |
| | dose | Percentage Control | calculated by | Control; |
| Treatment | (g or mL/ha) | (Observed) | Colby's formula | Conclusion |

10 days after second spray

| Zineb 75% | 1000 | 33.7 | — | — |
|---|---|---|---|---|
| WP | | | | |
| Tebuconazole | 750 | 41.1 | — | — |
| 25.9% EC | | | | |
| Tebuconazole + | 225 + 855 | 67.7 | — | — |
| Zineb WG | | | | |
| Colby's formula calculation: | | | 60.9 | +6.8; |
| | | | | Synergistic |

10 days after second spray-Season 2

| Zineb 75% | 1000 | 29.8 | — | — |
|---|---|---|---|---|
| WP | | | | |
| Tebuconazole | 750 | 48.2 | — | — |
| 25.9% EC | | | | |
| Tebuconazole + | 225 + 855 | 67.0 | — | — |
| Zineb WG | | | | |
| Colby's formula calculation: | | | 63.6 | +3.4; |
| | | | | Synergistic |

### EXAMPLE 3

Treatments evaluated, application rate employed, pathogens evaluated and resulting disease control with combination Carbendazim+Mancozeb (GR) are presented in the follow ing Tables 12-16.

TABLE 12

| | | Dose | | |
|---|---|---|---|---|
| Sr. | | Active ingredient | Product | Method of |
| No. | Ingredient | (g a.i./ha) | (kg or L/ha) | application |
| 1. | Carbendazim + | 240 + 1260 | 12.5 | Broadcasting |
| | Mancozeb (GR) | | | |
| 2. | Carbendazim + | 288 + 1512 | 15.0 | Broadcasting |
| | Mancozeb (GR) | | | |
| 3. | Mancozeb 75% (WP) | 1500 | 2.0 | Spray (500 L/ha) |
| 4. | Carbendazim 50% (WP) | 250 | 0.5 | Spray (750 L/ha) |
| 5. | Carbendazim 12% + | 563 | 0.75 | Spray (750 L/ha) |
| | Mancozeb 63% (WP) | | | |
| 6. | Untreated/control | — | — | — |

The comparative formulation was a solid formulation meant for dispersion/dissolution prior to being sprayed, according to the FAO definition of such solid formulations. Such a formulation is typically available commercially as a wettable powder (WP), which was used as a comparative formulation.

TABLE 13
Disease-Paddy Blast

| | | | | Difference |
|---|---|---|---|---|
| | | | Expected | between |
| | | | Percentage | observed and |
| | Formulation | Percentage | Control | expected |
| | dose | Control | calculated | Control; |
| Treatment | (Kg or L/ha) | (Observed) | by Colby's formula | Conclusion |
| Mancozeb 75% WP | 2.0 | 33.33 | — | — |
| Canbendazim | 0.5 | 54.91 | — | — |
| 50% WP | | | | |
| Carbendazim 12% + | 0.75 | 69.18 | — | — |
| Mancozeb 63% WP | | | | |
| Colby's formula calculation: | | | 69.93 | +0.75; |
| | | | | Additive |
| Carbendazim + | 12.5 | 72.24 | — | — |
| Mancozeb (GR) | | | | |
| Colby's formula calculation: | | | 69.93 | +2.31; |
| | | | | Synergistic |
| Carbendazim + | 15.0 | 73.60 | | |
| Mancozeb (GR) | | | | |
| Colby's formula calculation: | | | 69.93 | +3.67; |
| | | | | Synergistic |

Paddy Sheath Blight

| | | | | |
|---|---|---|---|---|
| Mancozeb | 2.0 | 21.31 | — | — |
| 75% WP | | | | |
| Canbendazim | 0.5 | 37.00 | — | — |
| 50% WP | | | | |
| Carbendazim + | 12.5 | 72.24 | 50.43 | +21.81; |
| Mancozeb (GR) | | | | Synergistic |
| Carbendazim + | 15.0 | 73.60 | 50.43 | +23.17; |
| Mancozeb (GR) | | | | Synergistic |

The formulation comprising Carbendazim+Mancozeb (GR) was a composition according to the present invention i.e. a solid formulation meant for direct use. In this embodiment, the formulation was a granular formulation (GR).

In an embodiment, the minimum dosage of above present formulation was maintained at greater than at least 10.0 kg/ha.

TABLE 14
Disease-Sheath Blight

| | | | | Difference |
|---|---|---|---|---|
| | | | Percentage | between |
| | | | control | observed and |
| | Formulation | Percentage | Expected | expected |
| | dose | Control | calculated | Control; |
| Treatment | (Kg or L/ha) | (Observed) | by Colby's formula | Conclusion |
| Mancozeb | 2.0 | 27.80 | — | — |
| 75% WP | | | | |
| Canbendazim | 0.5 | 36.82 | — | — |
| 50% WP | | | | |
| Carbendazim 12% + | 0.75 | 52.39 | — | — |
| Mancozeb | | | | |
| 63% WP | | | | |
| Colby's formula calculation: | | | 54.38 | −1.99; Not |
| | | | | synergistic |
| Carbendazim + | 12.5 | 64.58 | — | — |
| Mancozeb (GR) | | | | |
| Colby's formula calculation: | | | 54.38 | +10.20; |
| | | | | Synergistic |
| Carbendazim + | 15.0 | 66.59 | | |
| Mancozeb (GR) | | | | |
| Colby's formula calculation: | | | 54.38 | +12.21; |
| | | | | Synergistic |

In furtherance to the results in above trials, a separate trial was conducted to evaluate the efficacy of a WP formulation comprising these fungicides to reconfirm the merely additive/antagonistic activity of the comparative WP formulation.

TABLE 15
Disease-Paddy Sheath Blight

| | | | | Difference |
|---|---|---|---|---|
| | | | Percentage | between |
| | | | Control | observed and |
| | Formulation | Percentage | Expected | expected |
| | dose | Control | calculated | Control; |
| Treatment | (Kg or L/ha) | (Observed) | by Colby's formula | Conclusion |
| Mancozeb WP 75% | 2.0 | 45.12 | — | — |
| Canbendazim | 0.5 | 58.80 | — | — |
| 50% WP | | | | |
| Carbendazim 12% + | 0.75 | 76.87 | — | — |
| Mancozeb 63% WP | | | | |
| Colby's formula calculation: | | | 90.47 | −13.6; Not |
| | | | | synergistic |

A confirmatory trial was then conducted to reconfirm the unexpected synergy seen with the solid formulation meant for direct use (GR) vis-à-vis the activity of a solid formulation meant for dissolution/dispersion (WP) above. The objective of the present invention was to reassess the findings of the above described trials.

TABLE 16
Disease-Paddy Blast

| | | | Percentage | Difference |
|---|---|---|---|---|
| | | | Control | between |
| | | | Expected | observed and |
| | Formulation | Percentage | calculated by | expected |
| | dose (Kg or | Control | Colby's | Control; |
| Treatment | L/ha) | (Observed) | formula | Conclusion |
| Mancozeb | 2.0 | 19.66 | — | — |
| 75% WP | | | | |
| Canbendazim | 0.5 | 36.61 | — | — |
| 50% WP | | | | |
| Colby's formula calculation: | | | 49.07 | — |
| Carbendazim + | 12.5 | 58.94 | — | +9.97; |
| Mancozeb (GR) | | | | Synergistic |
| Carbendazim + | 15.0 | 62.02 | — | +12.95; |
| Mancozeb (GR) | | | | Synergistic |

It was thus found that the fungicides mancozeb and carbendazim interacted synergistically when presented as a solid formulation meant for direct use, whereas they were merely additive or antagonistic when presented as a solid formulation meant for dispersion/dissolution.

### Example 4

Formulation:

Preparation of synergistic combination of copper sulphate 47.15% and Mancozeb 30%:

| Ingredients | % w/w |
|---|---|
| Copper sulpfate | 47.15 |
| Mancozeb | 30 |
| Alkyl naphthalene sulfonate | 7 |
| condensate sodium salt | |
| Kaolinite Clay | q.s. |
| Total | 100% w/w |

The bead milling instrument was charged with a suspension of copper sulphate (47.15% in water) wetting and dispersing agent. The premix was milled for 45 seconds to obtain a blend. Mancozeb technical was slurried together with kaolinic clay into the copper sulphate blend. This slurry (liquid suspension) was pumped into the nozzles of a spray dryer. The water from the droplets was evaporated in a hot air stream at inlet temperature of 120° C. and outlet temperature of 80° C. to obtain granules.

### Example 5

Field Trial:

Treatment with composition of present invention was given to crops in different season and evaluated % Disease intensity of Downy Mildew, powdery mildew and Anthracnose, Grape-berry yield at harvest and Phytotoxicity.

It has been observed that the composition had no phytotoxicity sign and was safe for grapevines for controlling the diseases. It was observed that yield of fresh marketable berries was significantly increased in the plots sprayed with present composition as compared to control and other plots. However, it was found that due to very low infection of anthracnose and downy mildew occurred in the vines sprayed with present invention improved the berry yield in the grape.

Percentage of disease control with the composition of the present invention was calculated using Colby equation.

The following equation was used to calculate the expected activity of mixtures containing two active ingredients, for example A and B:

Expected=A+B−(A×B/100)

A=observed efficacy of active component A at the same concentration as used in the mixture;

B=observed efficacy of active component B at the same concentration as used in the mixture.

Treatments evaluated, application rate employed, pathogens evaluated and resulting disease control are presented in the following Tables 17-18.

TABLE 17

| | | Dose | |
|---|---|---|---|
| Sr. | | Active ingredient | Method of |
| No. | Ingredient | (g a.i./ha) | application |
| 1. | Mancozeb + | 5 | Spray |
| | Copper sulphate | | |
| | (WDG) | | |
| 2. | Mancozeb + | 6 | Spray |
| | Copper sulphate | | |
| | (WDG) | | |
| 3. | Mancozeb 75% | 2 | Spray |
| | (WP) | | |
| 4. | Copper oxychloride | 2.5 | Spray |
| | 50% (WP) | | |
| 5. | Mancozeb + | 0.23575% | Spray |
| | Copper sulphate | | |
| | (WP) | | |
| 6. | Untreated/control | — | |

The comparative formulation was a solid formulation meant for dispersion/dissolution prior to being sprayed, according to the FAO definition of such solid formulations. Such a formulation is typically available commercially as a wettable powder (WP), which was used as a comparative formulation.

TABLE 18
Effect of present composition against anthracnose, powdery and
downy mildew diseases of grapes (mean of Season I and Season II)

| | Disease - Anthracnose | | | | | | |
|---|---|---|---|---|---|---|---|
| | | | | Expected | | Difference | |
| | | | | Percentage | | between | |
| | | Percentage | Percentage | Control | | observed | |
| | | Control | Control | calculated by | | and | |
| | Formulation | (Observed) | (Observed) | Colby's formula | | expected | |
| | dose (Kg or | Leaf | Cluster | Leaf | Cluster | Control; | |
| Treatment | L/ha) | infection | infection | infection | infection | Conclusion | |
| Untreated | — | — | — | — | | — | |
| Mancozeb | 2.0 | 26.01 | 56.72 | — | | — | |
| 75% WP | | | | | | | |
| Copper | 2.5 | 53.78 | 74.53 | — | | — | |
| Oxychloride | | | | | | | |
| 50% WP | | | | | | | |
| Mancozeb + | 0.235% | 39.75 | 66.01 | — | | — | |
| Copper WP | | | | | | | |
| Colby's formula calculation: | | | | 65.81 | 88.97 | −26.02 | −22.96 |
| | | | | | | Antagonistic | |
| Mancozeb + | 5 | 81.46 | 83.39 | | | +41.71 | +17.38 |
| copper | | | | | | Synergistic | Synergistic |
| sulphate | | | | | | | |
| (GR) | | | | | | | |
| Mancozeb + | 6 | 85.41 | 84.74 | | | +45.66 | +18.73 |
| copper | | | | | | Synergistic | Synergistic |
| sulphate | | | | | | | |
| (GR) | | | | | | | |
| | Disease - Powdery Mildew | | | | | | |
| | | Percentage | Percentage | Expected | | | |
| | | Control | Control | Percentage | | | |
| | Formulation | (Observed) | (Observed) | Control | | Difference between obs [symbol] | |
| | dose (Kg or | Leaf | Cluster | calculated by | | and expected Co [symbol] | |
| Treatment | L/ha) | infection | infection | Colby's formula | | Conclusion | |
| Untreated | — | — | | — | | — | |
| Mancozeb | 2.0 | 52.02 | 48.78 | — | | — | |
| 75% WP | | | | | | | |
| Copper | 2.5 | 68.27 | 70.63 | — | | — | |
| Oxychloride | | | | | | | |
| 50% WP | | | | | | | |
| Mancozeb + | 0.235% | 67.04 | 67.76 | — | | — | |
| Copper WP | | | | | | | |
| Colby's | | | | 84.77 | 84.96 | −17.73 | −17.2 [symbol] |
| formula | | | | | | Antagonistic | Antago [symbol] |
| calculation: | | | | | | | |
| Mancozeb + | 5 | 83.34 | 84.43 | | | −1.43 | −0.53 [symbol] |
| copper | | | | | | (Additive) | (Ad [symbol] |
| sulphate | | | | | | | e) |
| (GR) | | | | | | | |
| Mancozeb + | 6 | 85.12 | 85.45 | | | +0.35 | +0.49 (Ad [symbol] |
| copper | | | | | | (Additive/ | /Synergisti [symbol] |
| sulphate | | | | | | Synergistic) | |
| (GR) | | | | | | | |

| | Disease - Downy Mildew | | | | |
|---|---|---|---|---|---|
| | | Percentage | Percentage | Expected | |
| | | Control | Control | Percentage | |
| | Formulation | (Observed) | (Observed) | Control | Difference between obs [symbol] |
| | dose | Leaf | Cluster | calculated by | and expected Co [symbol] |
| Treatment | (Kg/ha) | infection | infection | Colby's formula | Conclusion |
| Untreated | — | — | | — | — |
| Mancozeb | 2.0 | 56.30 | 53.12 | — | — |
| 75% WP | | | | | |
| Copper | 2.5 | 72.24 | 74.04 | — | — |
| Oxychloride | | | | | |
| 50% WP | | | | | |
| Mancozeb + | 0.235% | 65.47 | 70.93 | — | — |
| Copper | | | | | |
| (WP) | | | | | |

| | | | | |
|---|---|---|---|---|
| Colby's formula calculation: | 87.86 | 87.82 | −22.39 | −16.8 [symbol] |
| | | | Antagonistic | Antagonisti [symbol] |

[symbol]

indicates data missing or illegible when filed

The formulation comprising Mancozeb+copper sulphate (GR) was a composition according to the present invention i.e. a solid formulation meant for direct use. In this embodiment, the formulation was a granular formulation (GR).

It was thus found that the fungicides mancozeb and copper sulphate interacted synergistically when presented as a solid formulation meant for direct use e.g. as a WDG or GR formulation, whereas they were merely additive or antagonistic when presented as a solid formulation meant for dispersion/dissolution e.g. as a WP formulation.

Therefore, according to an embodiment, the composition of the present invention is a solid composition.

In an embodiment, the solid composition of the present invention is not a composition meant for dissolution or dispersion before use.

In an embodiment, the solid composition of the present invention is not a wettable powder composition.

In an embodiment, the solid composition of the present invention is a composition meant for direct use i.e. without dissolution or dispersion.

In an embodiment, the composition of the present invention is a granular (GR) composition.

In an embodiment, the composition of the present invention is a wettable granules (WG) composition.

1. A fungicidal composition comprising a dithiocarbamate fungicide and at least one another fungicide, wherein said composition is a solid formulation formulated for direct use.

2. The composition as claimed in claim 1, wherein said dithiocarbamate fungicide is selected from group consisting of amobam, asomate, azithiram, carbamorph, cufraneb, cuprobam, disulfiram, ferbam, metam, nabam, tecoram, thiram, urbacide, ziram, dazomet etem, milneb, zineb, propineb, maneb, mancopper, mancozeb, metiram or polycarbamate, and combinations thereof.

3. The composition as claimed in claim 1, wherein said dithiocarbamate fungicide is mancozeb.

4. The composition as claimed in claim 1, wherein said another fungicide is selected from the group consisting of a triazole, a strobilurin, a succinate dehydrogenase inhibitor, a benzimidazole, a benzimidazole precursor, a benzimidazole carbamate fungicide, copper fungicide, and combinations thereof.

5. The composition as claimed in claim; wherein said triazole is selected from group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, and combinations thereof.

6. The composition as claimed in claim 4, wherein said succinate dehydrogenase inhibitor is selected from group consisting of benzovindiflupyr, bixafen, fluxapyroxad, furametpyr, isopyrazam, penflufen, penthiopyrad, 3-difluoromethyl-N-(7-fluoro-1, 1, 3-trimethyl-4-indanyl)-1-methyl-4-pyrazolecarboxamide, sedaxane, and combinations thereof.

7. The composition as claimed in claim 4, wherein said benzimidazole precursor fungicide is selected from the group consisting of furophanate, thiophanate, thiophanate-methyl, and combinations thereof.

8. The composition as claimed in claim 1, wherein said dithiocarbamate fungicide is present in an amount of about 40-60% by weight of the composition, based on the total weight of the composition.

9. The composition as claimed in claim 1, wherein said second fungicide is present in an amount of about 10-30% by weight of the composition, based on the total weight of the composition.

10. A solid composition comprising a dithiocarbamate fungicide and a second fungicide, wherein said dithiocarbamate fungicide is in an amount of 40-60% by weight of the composition and second fungicide is an amount of 10-30% by weight of the composition, based on the total weight of the composition, wherein the composition is a solid composition formulated for direct use.

11. The solid composition as claimed in claim 10, comprising mancozeb an amount of 40 to 60% by weight and thiophanate methyl in an amount of 20 to 30% by weight, based on the total weight of the composition, wherein said mancozeb and thiophanate methyl are present in a ratio of 2:1.

12. The solid composition as claimed in claim 10, comprising zineb in an amount of 55 to 60% by weight and tebuconazole present in an amount of 10 to 20% by weight, based on the total weight of the composition, wherein said zineb and tebuconazole are present in a ratio of 4:1.

13. The composition as claimed in claim 10, wherein said dithiocarbamate fungicide is mancozeb in an amount of 50% by weight of the composition, based on the total weight of the composition.

14. The composition as claimed in claim 10, wherein said dithiocarbamate fungicide is zineb in an amount of 57% by weight of the composition, based on the total weight of the composition.

15. The composition as claimed in claim 10, wherein said another fungicide is tebuconazole in an amount of 15% by weight of the composition.

16. The composition as claimed in claim 10, wherein said another fungicide is thiophanate methyl an amount of 25% by weight of the composition, based on the total weight of the composition.

17. The composition as claimed in claim 1, further comprising an agrochemically acceptable carrier, filler, or combinations thereof.

18. The composition as claimed in claim 17, wherein said agrochemically acceptable carrier is selected from at least one dispersing agent, at least one wetting agent, at least one antifoam, at least one surfactant, and combinations thereof.

19. The composition as claimed in claim 18, wherein said wetting agent is selected from the group consisting of a salt of an ester of a substituted phenol, and sulfosuccinate.

20. The composition as claimed in claim 18, wherein said surfactant is selected from salts of polystyrenesulphonic acids; salts of polyvinylsulphonic acids; salts of naphthalenesulphonic acid/formaldehyde condensates; salts of condensates of naphthalenesulphonic acid, phenolsulphonic acid and formaldehyde; salts of lignosulphonic acid; sodium lignosulphonate, polyethylene oxide/polypropylene oxide block copolymers; polyethylene glycol ethers of linear alcohols; reaction products of fatty acids with ethylene oxide and/or propylene oxide; polyvinyl alcohol; polyvinylpyrrolidone; copolymers of polyvinyl alcohol and polyvinylpyrrolidone; copolymers of (meth)acrylic acid and (meth)acrylic esters; and alkyl ethoxylates; an alkylarylethoxylates, and combinations thereof.

21. The composition as claimed in claim 20, wherein said surfactant is selected from one or more of sodium alkyl naphthalene sulfonate, sodium diisopropylnaphthalenesulfonate, sodium salt of naphthalene sulfonate condensate, lignin sulfonate salts, and combination thereof.

22. The composition as claimed in claim 17, wherein said filler is-ae selected from one or more of precipitated silica, china clay, and kaolin.

23. The composition as claimed in claim 1, wherein said solid formulation is selected from a dustable powder (DP), a powder for dry seed treatment (DS), microgranules (MG), wettable granules (WG), granules (GR), or a tablet for direct dispersion (DT).

24. The composition as claimed in claim 23, wherein said solid formulation is granules (GR).

25. A solid composition according to claim 10, comprising mancozeb in an amount of 50% by weight and thiophanate methyl an amount of 25% by weight, based on the total weight of the composition, wherein said composition is a granular formulation meant for direct use.

26. The solid composition according to claim 10, comprising zineb in an amount of 57% by weight and tebuconazole in an amount of 15% by weight, wherein said composition is wherein said composition is a granular formulation meant for direct use.

27. A method of treating crop disease comprising applying to the crop composition of claim 1, wherein said crop disease is disease in rice.

28. The method as claimed in claim 27, wherein said crop diseases is selected from blast, Helminthosporium leaf spot, sheath blight, and bakanae disease.

29. The method as claimed in claim 28, wherein said crop diseases is selected from blast and sheath blight.

30. A fungicidal composition comprising a dithiocarbamate fungicide and a benzimidazole fungicide or a benzimidazolylcarbamate fungicide, wherein said composition is a solid formulation formulated for direct use.

31. The composition as claimed in claim 30, wherein said dithiocarbamate fungicide and benzimidazole fungicide or benzimidazolylcarbamate fungicide are present in a ratio of 10.08:1.92.

32. (canceled)

33. The composition as claimed in claim 30, wherein said dithiocarbamate fungicide is mancozeb.

34. The composition as claimed in claim 30, wherein said benzimidazole fungicide or benzimidazolylcarbamate fungicide is carbendazim.

35. The composition as claimed in claim 30, wherein carbendazim is in an amount of 1.92% by weight of the composition, based on the total weight of the composition.

36. The composition as claimed in claim 30, wherein mancozeb is an amount of 10.08% by weight of the composition, based on the total weight of the composition.

37. The composition as claimed in claim 30, further comprising an agrochemically acceptable carrier, filler, or a combination thereof.

38. The composition as claimed in claim 37, wherein said agrochemically acceptable carrier is selected from at least one dispersing agent, at least one wetting agent, at least one antifoam, at least one surfactant and combinations thereof.

39. The composition as claimed in claim 38, wherein said wetting agent is selected from the group consisting of a salt of an ester of a substituted phenol, and sulfosuccinate.

40. The composition as claimed in claim 37, wherein said filler re selected from one or more of precipitated silica, china clay, and kaolin.

41. A method of treating crop disease comprising applying to the crop composition of claim 30, wherein said crop disease is disease in rice.

42. The method of claim 41, wherein said crop diseases is selected from blast, Helminthosporium leaf spot, sheath blight, and bakanae disease.

43. The method of claim 42, wherein said crop diseases is selected from blast and sheath blight.

44. The composition as claimed in claim 30, wherein said solid formulation is selected from a dustable powder (DP), powder for dry seed treatment (DS), granules (GR), or a tablet for direct dispersion (DT).

45. The composition as claimed in claim 44, wherein said solid formulation is granules (GR).

46. A composition comprising mancozeb and a copper fungicide present in a ratio of about 1:1.5.

47. The composition as claimed in claim 4, wherein mancozeb is from about 25% to about 35% by weight of the composition based on the total weight of the composition.

48. The composition as claimed in claim 46, wherein the copper fungicide is from about 40% to about 50% by weight of the composition, based on the total weight of the composition.

49. The composition as claimed in claim 46, wherein said composition comprises about 30% by weight of mancozeb and 47.15% by weight of the copper fungicide, based on the total weight of the composition.

50. The composition as claimed in claim 46, wherein the copper fungicide is selected from copper oxychloride, copper sulfate, copper hydroxide, tribasic copper sulfate, and combinations thereof.

51. The composition as claimed in claim 46, formulated as granules, a dry flowable formulation, wettable granules, or water dispersible granules.

52. The composition as claimed in claim 46, wherein said composition is a solid formulation formulated for direct use.

53. The composition as claimed in claim 46, wherein the total weight of mancozeb and the copper fungicide together is about 75% by weight of the composition based on the total weight of the composition.

54. The composition as claimed in claim 53, wherein the composition is formulated as water dispersible granules.

55. The composition as claimed in claim 46, further comprising an agrochemically acceptable carrier, filler, or a combination thereof.

56. The composition as claimed in claim 55, wherein said agrochemically acceptable carrier is selected from at least one dispersing agent, at least one wetting agent, at least one antifoam, at least one surfactant, and combinations thereof.

57. The composition as claimed in claim 55, wherein said agrochemically acceptable carrier is selected from alkali aromatic aryl sulphonate, salts of condensates of naphthalenesulphonic acid, alkylarylsulfonatesalkylbenzenesulfonates; alkylnaphthalenesulfonates, and salts thereof.

58. A method of treating crop disease comprising applying to the crop the composition of claim 46, wherein said crop disease is disease in grape.

59. The method of claim 46 wherein said crop diseases is selected from anthracnose, powdery, and downy mildew diseases of grapes.

60. The composition as claimed in claim 46, wherein said composition is a solid formulation selected from a dustable powder (DP), a powder for dry seed treatment (DS), granules (GR), or a tablet for direct dispersion (DT).

61. The composition as claimed in claim 60, wherein said formulation is granules (GR).

62. A process for preparation of granular formulation comprising mancozeb and a copper fungicide, said process comprising:
a) blending mancozeb with the copper fungicide, optionally with at least one agrochemically acceptable carriers and water, to prepare a slurry;
b) homogenizing said slurry by wet milling; and
c) spray drying the slurry of step (b) to obtain granules.

63. A method for controlling pathogenic fungi at a locus, said method comprising contacting the locus with a composition comprising a mancozeb and a copper fungicide, wherein said mancozeb and copper fungicide are present in a ratio of about 1:1.5.

64. The composition as claimed in claim 4, wherein said strobilurin fungicide is selected from group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb, and mixtures thereof.
